(19) United States
(12) Patent Application Publication
(10) Pub. No.: US 2015/0140303 A1
(43) Pub. Date: May 21, 2015

(54) BI-ORIENTED POLYPROPYLENE FILM FOR ENVELOPE WINDOWS

(71) Applicants: Jesus Martin Gracia, Zaragoza (ES); Alfonso Jimenez Guardia, Lugo de Llanera (Asturias) (ES)

(72) Inventors: Jesus Martin Gracia, Zaragoza (ES); Alfonso Jimenez Guardia, Lugo de Llanera (Asturias) (ES)

(73) Assignee: EXTRUSION DE RESINAS VINILICAS S.A., Zaragoza (ES)

(21) Appl. No.: 14/387,970

(22) PCT Filed: Mar. 29, 2012
(86) PCT No.: PCT/ES2012/070212

§ 371 Date: Feb. 2, 2015

(51) Int. Cl. B32B 27/08; B32B 27/32; B32B 27/18

(52) U.S. Cl. CPC B32B 27/08; B32B 27/18; B32B 27/32; B32B 2250/24; B32B 2307/518
USPC 428/216; 428/518; 428/335; 428/336; 428/516

(57) ABSTRACT

Bi-oriented polypropylene film for envelope windows comprising two or more layers, the central layer or body of the film being composed, in the main, of polypropylene and at least one of the outer layers being compatible with adhesives.

The invention disclosed affords the main advantage of being totally compatible with the machinery or processes currently used to produce envelope windows with other films, promoting the use of polypropylene, with a reduction in consumption of between 15% and 35%, depending on the type of film that is replaced.

This description refers, as its title indicates, to a bi-oriented polypropylene film for envelope windows, characterized in that it comprises two or more layers, the central layer or body of the film being composed in the main of polypropylene and at least one or several of the outer layers being compatible with adhesives, having several competitive advantages over the plastic films currently used in this industry.

### FIELD OF THE INVENTION

The application for which this film is intended is the market for the manufacture of transparent window envelopes.

THE PRIOR ART The window envelope manufacturing industry currently uses various types of plastic films made with different polymers:

Films made with PS (polystyrene), films made with PET (polyethylene terephthalate) and films made with PLA (polylactic acid), although currently the most consumed polymer for this application is polystyrene.

All of these polymers have a high density since the application requires the plastic film to have a high degree of stiffness so that it can be processed in envelope production machines that operate at high speed. Thus the density of PS film is currently 1.05 g/cm³, the density of PET film is 1.40 g/cm³ and the density of PLA film is 1.27 g/cm³.

At the present time the most commonly used film for this application is that made with PS (polystyrene) produced by a bubble extrusion system.

Polypropylene is a material that until now has not been used for the manufacture of plastic films for windows due to the technical reason that its characteristics for fixing adhesives is not good, which limits or impedes its application in industrial uses that require adhesives to be applied in some of their processes.

### BACKGROUND OF THE INVENTION

Different applications of polypropylene films are known. For example, WO 2012016964 and WO 2011141380 patents disclose embodiments in bi-oriented polypropylene for electronic applications, especially in the manufacture of condensers.

Spanish patents ES2336457 ES2287784, ES2235997T and ES2185840T are examples of the many embodiments of polypropylene films for the manufacture of packaging and food applications, without adhesives.

Patent GB2479561 describes labels for bottles or cans with a BOPP polypropylene core mixed with an additive treated by corona discharge and a pressure sensitive adhesive, but it does not have a specific layer to support the subsequent coating of an adhesive.

PCT/ES2009/070145 provides a simplification of the known conventional process for the manufacture of biaxially-oriented polypropylene film by eliminating the processes of separate coating and of secondary cutters, reducing the by-products and achieving energy savings by combining the layers in their initial processing phase, but it is not envisaged for manufacturing films for envelope windows nor does it include any specific layer to enhance the fixing of the adhesive.

### DESCRIPTION OF THE INVENTION

To solve the problems that exist at present in the manufacture of envelope windows using polypropylene films, providing an alternative to currently existing films, the bi-oriented polypropylene film for envelope windows that is the object of this invention has been devised, being formed by two or more layers, able to form various layer structures, in such a way that the central layer is, in the main, made of polypropylene and at least one of the outer layers is compatible with the adhesives currently used to manufacture envelopes with windows.

This compatibility of the outer layer with the adhesives is achieved by using one or several polymers chosen from the group: EVA (ethyl vinyl acetate), EBA (ethyl butyl acrylate), EMA (ethyl methyl acrylate), EEA (ethylene ethyl acrylate), EAA (ethylene acrylic acid), polypropylene ethylene butene terpolymer, antiblocking and slip additives based on the previous polymers.

The outer face of the film may optionally be treated with corona treatment, flame treatment or chemical treatment during the manufacturing process.

Additionally the film may have another outer layer to improve the antistatic, antibocking and slip properties of the film, as well as to modify the degree of transparency of the same. Furthermore, it is envisaged that two intermediate layers may be used to improve the stiffness of the film as well as to improve the compatibility between the outer layers and the central layer or body of the film.

Advantages of the invention

The bi-oriented polypropylene film for envelope windows that is presented provides multiple advantages over currently available films, the most important being that it allows the use of a film of the same thickness but a lesser weight and with identical characteristics to the current ones, which represents a reduction in consumption of plastic films in the manufacture of envelopes with windows of between 15% and 35%, depending on the type of film replaced, with the consequent economic savings in the process.

Another important advantage of this film is that it can be used as an alternative by envelope manufacturers in a totally compatible way, without any type of change in the machinery or processes currently used with other films that are not polypropylene but rather polystyrene.

Another of the major advantages to be noted is that it enables a film to be obtained that has greater transparency and less residues, while at the same time it has very good adhesion characteristics and does not easily come unstuck.

### DESCRIPTION OF THE FIGURES

To gain a better understanding of the object of the present invention, the attached drawing shows four practical, preferred embodiments of a bi-oriented polypropylene film for envelope windows.

In said drawing FIG. 1 shows a diagram of the basic structure of the film composed of a main layer (1) the purpose of which is to provide the main mechanical properties of the film, such as stiffness, tenacity, etc. . . . , and whose composition will be the same in all of the structures employed, and an outer layer or skin (2) whose primary function is to facilitate the adhesion of the film to envelope papers by means of adhesives. The composition and thickness of this layer remain constant for all of the possible structures of the film

FIG. 2 shows a diagram of the alternative embodiment of the structure of a film in which, to the first two layers (1) and (2), another outer layer (3) is added in order to improve optical and physical properties such as the coefficient of friction, antiblocking properties, antistatic properties, etc.

FIG. 3 shows a diagram of another alternative embodiment of the structure of a film in which, to the first two layers of FIG. 1, another outer layer (2) is added in order to improve optical and physical properties such as the coefficient of friction, antiblocking properties, antistatic properties, etc.

FIG. 4 shows the diagram of another alternative embodiment of the structure of a film in which, the three layers of FIG. 2 have two layers (4) inserted between the body and the outer skin in order to improve the stiffness of the film and the compatibility between the outer layers (2,3) and the central layer (1) of the film.

### PREFERRED EMBODIMENT OF THE INVENTION

The bi-oriented polypropylene film for envelope windows that is the object of the present invention basically comprises, as can be seen in the attached drawing, two or more layers.

The central layer (1) or body of the film is composed of between 70% and 98% polypropylene, between 1% and 30% of a totally or partially hydrogenated resin, preferably between 5% and 15%, and between 1% and 10% of antistatic and slip additives based on polypropylene, preferably between 1% and 5%. Its thickness is between 18 μ and 35 μ, preferably between 25 μ and 32 μ

At least one of the outer layers (2) is compatible with the adhesives currently used in the market and will be responsible for allowing the film to adhere to the envelope paper. This outer layer or layers (2) are composed of one or a mix of several polymers chosen from the group: EVA (ethyl vinyl acetate), EBA (ethyl butyl acrylate), EMA (ethyl methyl acrylate), EEA (ethylene ethyl acrylate), EAA (ethylene acrylic acid), polypropylene ethylene butene terpolymer, antiblocking and slip additives based on the previous polymers. The thickness of the outer layer or layers (2) is between 0.7 μ and 1.5 μ, preferably between 0.9 μ and 1.2 μ.

It is envisaged that, during the manufacturing process, the outer layer or layers (2) may optionally receive corona treatment, flame treatment or chemical treatment aimed at improving the adhesion of the adhesives used in forming the envelopes.

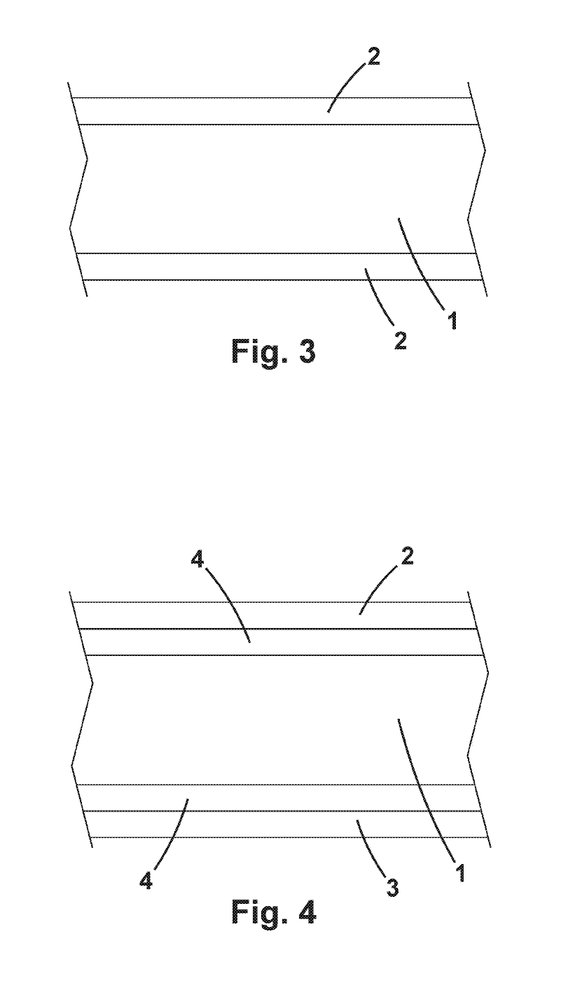

In a preferred embodiment it is envisaged that the film is formed only by the central layer (1) and one outer layer (2) as shown in FIG. 1, although in an alternative embodiment it is envisaged with two outer layers (2), as shown in FIG. 3.

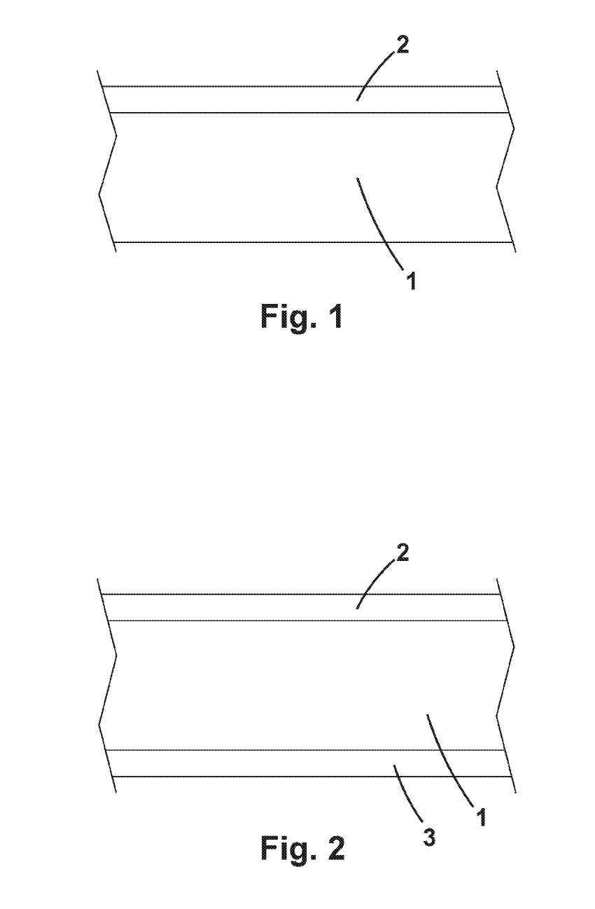

Alternatively, as shown in FIG. 2, it is envisaged that the film comprises another outer layer (3) that improves the antistatic, antiblocking and slip properties of the film, located on the opposite face to the outer layer (2) and being composed of one or a mix of several polymers chosen from the group: polypropylene, polypropylene ethylene copolymer and polypropylene ethylene butene terpolymer plus antistatic, slip and antiblocking additives. This outer layer (3) has a thickness of between 0.6 μy 3 μ.

Also alternatively, as shown in FIG. 4, it is envisaged that the film comprises one or two intermediate layers (4) to improve stiffness as well as improving compatibility between the outer layers (2,3) and the central layer (1) or body of the film, located between the central layer (1) and the outer layer or layers (2,3), being composed of one or a mix of several polymers chosen from the group: EVA (ethyl vinyl acetate), EBA (ethyl butyl acrylate), EMA (ethyl methyl acrylate), EEA (ethylene ethyl acrylate), EAA (ethylene acrylic acid), polypropylene, ethylene polypropylene copolymer, polypropylene ethylene butane terpolymer, totally or partially hydrogenated resin. This intermediate layer (4) has a thickness of between 0.6 μ and 1 μ.

1. Bi-oriented polypropylene film for envelope windows characterized in that it comprises two or more layers, the core layer (1) or body of the film being composed in the main of polypropylene, and at least one of the outer layers (2) being compatible with adhesives and being composed of one or a mix of several polymers chosen from the group: EVA (ethyl vinyl acetate), EBA (ethyl butyl acrylate), EMA (ethyl methyl acrylate), EEA (ethylene ethyl acrylate), EAA (ethylene acrylic acid), polypropylene ethylene butene terpolymer, antiblocking and slip additives based on the previous polymers.

2. Bi-oriented polypropylene film for envelope windows, according to claim 1, wherein both outer layers (2) are compatible with adhesives and are composed of one or a mix of several polymers chosen from the group: EVA (ethyl vinyl acetate), EBA (ethyl butyl acrylate), EMA (ethyl methyl acrylate), EEA (ethylene ethyl acrylate), EAA (ethylene acrylic acid), polypropylene ethylene butene terpolymer, antiblocking and slip additives based on the previous polymers.

3. Bi-oriented polypropylene film for envelope windows, according to claim 1, wherein the core layer (1) is composed of between 70% and 98% polypropylene, between 1% and 30% of a totally or partially hydrogenated resin, preferably between 5% and 15%, and between 1% and 10% of antistatic and slip additives based on polypropylene, preferably between 1% and 5%.

4. Bi-oriented polypropylene film for envelope windows, claim 1, wherein the core layer (1) has a thickness of between 18 μ and 35 μ.

5. Bi-oriented polypropylene film for envelope windows, claim 1, wherein the core layer (1) has a thickness of between 25 μ and 32 μ.

6. Bi-oriented polypropylene film for envelope windows, according to claim 1, wherein the outer layer or layers (2) have a thickness of between 0.7 μ and 1.5 μ.

7. Bi-oriented polypropylene film for envelope windows, according to claim 1, wherein the outer layer or layers (2) have a thickness of between 0.9 μ and 1.2 μ.

8. Bi-oriented polypropylene film for window envelopes, according to claim 1, wherein the outer layer or layers (2) have received corona treatment, flame treatment or chemical treatment during the manufacturing process.

9. Bi-oriented polypropylene film for window envelopes, according to claim 1, wherein the film comprises another outer layer (3) to improve properties, located on the opposite face to the outer layer (2) and being composed of one or a mix of several polymers chosen from the group: polypropylene, polypropylene ethylene copolymer and polypropylene ethylene butene terpolymer plus antistatic, slip and antiblocking additives.

10. Bi-oriented polypropylene film for envelope windows, according to claim 9, wherein the outer layer (3) has a thickness of between 0.6 μ and 3 μ.

11. Bi-oriented polypropylene film for window envelopes, according to claim 1, wherein the film comprises one or two intermediate layers (4) to improve stiffness, located between the core layer (1) and the outer layer or layers (2,3), being composed of one or a mix of several polymers selected from the group: EVA (ethyl vinyl acetate), EBA (ethyl butyl acrylate), EMA (ethyl methyl acrylate), EEA (ethylene ethyl acrylate), EAA (ethylene acrylic acid), polypropylene, ethylene polypropylene copolymer, polypropylene ethylene butene terpolymer, totally or partially hydrogenated resin.

12. Bi-oriented polypropylene film for envelope windows, according to claim 11, wherein the intermediate layer (4) has a thickness of between 0.6 μ and 1 μ.
